(19) United States
(12) Patent Application Publication
(10) Pub. No.: US 2026/0031410 A1
(43) Pub. Date: Jan. 29, 2026

(54) METHOD AND APPARATUS FOR LEAK TESTING A BATTERY CELL

(71) Applicant: GM GLOBAL TECHNOLOGY OPERATIONS LLC, Detroit, MI (US)

(72) Inventors: Hassan Ghassemi-Armaki, Northville, MI (US); Blair E. Carlson, Ann Arbor, MI (US); Ruiyao Wang, Walled Lake, MI (US); Cedrick D. Riley, Northville, MI (US)

(73) Assignee: GM GLOBAL TECHNOLOGY OPERATIONS LLC, Detroit, MI (US)

(21) Appl. No.: 18/780,638

(22) Filed: Jul. 23, 2024

(51) Int. Cl. H01M 10/42; G01M 3/00; G01M 3/22

(52) U.S. Cl. CPC H01M 10/4228; G01M 3/002; G01M 3/226

(57) ABSTRACT

A leak testing system includes a first test station, a second test station, a conveyor, and a controller. The first test station includes a first infrared camera equipped with a first optical CO2 lens filter, a first backdrop including a first heated surface and a first mirror, a first vacuum source, and a first CO2 gas delivery system. The second test station includes a second infrared camera equipped with a second optical CO2 lens filter, a second backdrop including a second heated surface and a second mirror, a second vacuum source, and a second CO2 gas delivery system. The first infrared camera is disposed to monitor a first field of view that includes the first backdrop. The second infrared camera is disposed to monitor a second field of view that includes the second backdrop. The controller includes a cell test procedure that is captured in algorithmic code.

### INTRODUCTION

A rechargeable energy storage system (RESS) can be employed in a stationary energy storage system or in a mobile device, e.g., as part of an electric vehicle (EV). When employed as part of an EV, an electric powertrain employs one or multiple electric machines to generate torque employing energy derived at least in part from an RESS, with the generated torque being delivered to a drivetrain for tractive effort.

An RESS may include a battery cell pack that is composed of a plurality of prismatic-shaped pouch-type electrochemical battery cells. The battery cells may be lithium ion battery cells in one embodiment, although the disclosure is not so limited. Battery cells may include lithium-class batteries, nickel-metal hydride batteries, ultracapacitor batteries, and lead-acid batteries. As per lithium-class designs, lithium-metal and lithium-ion (Li-ion) batteries make up the bulk of commercial lithium battery (LiB) configurations, with Li-ion batteries being employed in automotive applications due to their enhanced stability, energy density, and rechargeable capabilities. A lithium-ion cell may include at least two conductive electrodes, an electrolyte material, and a permeable separator, all of which are enclosed inside an electrically insulated packaging that contains an electrolyte.

### SUMMARY

During the manufacture of rechargeable battery cells, especially lithium-metal, prismatic-type cells, a metered volume of compressed gas, such as carbon dioxide (CO₂), may be injected into the cell's rigid battery case in order to pressurize the cell for purposes of leak testing. To ensure continuous and uninterrupted operation of the battery system, each cell is tested during the manufacturing process to confirm that there are no leaks in the cell.

The concepts described herein provide elements related to a method, system and/or apparatus for non-destructive leak testing of a prismatic battery cell, including in a manner that may include identifying a location of a leak to facilitate repair and fabrication process review.

An aspect of the disclosure may include a leak testing system that includes a first test station, a second test station, a conveyor, and a controller. The first test station is connected to the second test station via the conveyor. The first test station includes a first infrared camera equipped with a first optical CO2 lens filter, a first backdrop including a first heated surface and a first mirror, a first vacuum source, and a first CO2 gas delivery system. The second test station includes a second infrared camera equipped with a second optical CO2 lens filter, a second backdrop including a second heated surface and a second mirror, a second vacuum source, and a second CO2 gas delivery system. The first infrared camera is disposed to monitor a first field of view that includes the first backdrop when the first backdrop is in a first test position. The second infrared camera is disposed to monitor a second field of view that includes the second backdrop when the second backdrop is in a second test position. The controller is in communication with the first test station, the second test station, and the conveyor. The controller includes a cell test procedure that is captured in algorithmic code that is stored in non-volatile memory. The cell test procedure includes the following steps, including arranging an unfilled prismatic battery cell (cell) at the first test station; arranging the first backdrop in the first test position, wherein the first test position is proximal to a first portion of the cell; pressurizing the cell employing CO2 gas at the first test station; monitoring, via the first infrared camera, an exterior portion of the first portion of the cell and the backdrop to detect presence of CO2 gas; transporting, via the conveyor, the cell to the second test station; arranging the second backdrop in the second test position, wherein the second test position is proximal to a second portion of the cell; pressurizing the cell employing CO2 gas at the second test station; monitoring, via the second infrared camera, an exterior portion of the second portion of the cell and the backdrop to detect presence of CO2 gas; detecting, via the controller, a leak in the cell when the first infrared camera detects a presence of CO2 gas proximal to the exterior portion of the first portion of the cell; and detecting, via the controller, a leak in the cell when the second infrared camera detects a presence of CO2 gas proximal to the exterior portion of the second portion of the cell.

Another aspect of the disclosure may include the first backdrop being a C-channel having a web portion and first and second side portions, wherein the web portion and the first and second side portions are arranged to encompass the first portion of the cell when the first backdrop is arranged in the first test position.

Another aspect of the disclosure may include the second backdrop being a C-channel having a web portion and first and second side portions, wherein the web portion and the first and second side portions are arranged to encompass the second portion of the cell when the second backdrop is arranged in the first test position.

Another aspect of the disclosure may include the first backdrop being a first C-channel portion fabricated from aluminum, and wherein the first backdrop includes a surface treatment capable of absorbing infrared light.

Another aspect of the disclosure may include the second backdrop being a second C-channel portion fabricated from aluminum, and wherein the second backdrop includes a surface treatment capable of absorbing infrared light.

Another aspect of the disclosure may include a first environmental enclosure and a second environmental enclosure, wherein the first test station is disposed in the first environmental enclosure, and wherein the second test station is disposed in the second environmental enclosure.

Another aspect of the disclosure may include the cell test procedure further including a step to identify, via the controller, a location of the leak on the cell when the first infrared camera detects presence of CO2 gas proximal to the exterior portion of the first portion of the cell.

Another aspect of the disclosure may include the cell test procedure further including a step to identify, via the controller, a location of the leak on the cell when the second infrared camera detects presence of CO2 gas proximal to the exterior portion of the second portion of the cell.

Another aspect of the disclosure may include the first backdrop being attached via a first extender to a first frame portion of the first test station, with the first extender being controllable to one of a retracted state and an extended state. The cell test procedure further includes steps to control the first extender to the extended state prior to the step to arrange the first backdrop and the first mirror in the first test position; and control the first extender to the retract state prior to the step to transport, via the conveyor, the cell to the second test station.

Another aspect of the disclosure may include the second backdrop being attached via a second extender to a second frame portion of the second test station. The second extender is controllable to one of a retracted state and an extended state. The cell test procedure further includes a step to control the second extender to the extended state prior to the step to arrange the second backdrop and the second mirror in the second test position.

Another aspect of the disclosure may include the cell test procedure further including steps to pressurize the cell employing CO2 gas at the first test station to a predetermined pressure level; and monitor, via the first infrared camera, the exterior portion of the first portion of the cell to detect presence of CO2 gas when pressure in the cell at the first test station is at the predetermined pressure level.

Another aspect of the disclosure may include the cell test procedure further including steps to pressurize the cell employing CO2 gas at the second test station to a predetermined pressure level; and monitor, via the second infrared camera, the exterior portion of the second portion of the cell to detect presence of CO2 gas when pressure in the cell at the second test station is at the predetermined pressure level.

Another aspect of the disclosure may include a leak testing system that includes a first test station arranged in a first environmental enclosure, a second test station arranged in a second environmental enclosure, a conveyor, and a controller; wherein the first test station is connected to the second test station via the conveyor; wherein the first test station includes a first camera, a first backdrop, a first mirror, and a first gas delivery system; wherein the second test station includes a second camera, a second backdrop, a second mirror, and a second gas delivery system; wherein the first camera is disposed to monitor a first field of view that includes the first backdrop when the first backdrop is in a first test position; wherein the second camera is disposed to monitor a second field of view that includes the second backdrop when the second backdrop is in a second test position; and wherein the controller is in communication with the first test station, the second test station, and the conveyor. The controller includes a cell test procedure that is captured in algorithmic code that is stored in non-volatile memory, wherein the cell test procedure includes the following steps: pressurize the cell with gas via the first gas delivery system at the first test station; monitor, via the first camera, an exterior portion of a first portion of the cell to detect presence of the gas; transport, via the conveyor, the cell to the second test station; pressurize the cell with the gas via the second gas delivery system at the second test station; monitor, via the second camera, an exterior portion of a second portion of the cell to detect presence of the gas; detect, via the controller, a leak in the cell when the first camera detects presence of the gas proximal to the exterior portion of the first portion of the cell; and detect, via the controller, a leak in the cell when the second camera detects presence of the gas proximal to the exterior portion of the second portion of the cell.

Another aspect of the disclosure may include a method for leak testing, the method including arranging an unfilled prismatic battery cell (cell) at a first test station; arranging a first backdrop and a first mirror in a first test position, wherein the first test position is proximal to a first portion of the cell; pressurizing the cell employing CO2 gas; monitoring, via a first infrared camera, an exterior portion of the first portion of the cell to detect presence of CO2 gas; transporting the cell to a second test station; arranging a second backdrop and a second mirror in a second test position, wherein the second test position is proximal to a second portion of the cell; pressurizing the cell employing CO2 gas; monitor, via a second infrared camera, an exterior portion of the second portion of the cell to detect presence of CO2 gas; detecting, via a controller in communication with the first infrared camera, a leak in the cell when the first infrared camera detects a presence of CO2 gas proximal to the exterior portion of the first portion of the cell; and detecting, via the controller in communication with the second infrared camera, a leak in the cell when the second infrared camera detects a presence of CO2 gas proximal to the exterior portion of the second portion of the cell.

Another aspect of the disclosure may include identifying, via the controller, a location of the leak on the cell when the first infrared camera detects presence of CO2 gas proximal to the exterior portion of the first portion of the cell; and identifying, via the controller, the location of the leak on the cell when the second infrared camera detects presence of CO2 gas proximal to the exterior portion of the second portion of the cell.

Another aspect of the disclosure may include pressurizing the cell employing CO2 gas at the first test station to a predetermined pressure level; monitoring, via the first infrared camera, the exterior portion of the first portion of the cell to detect presence of CO2 gas when pressure in the cell at the first test station is at the predetermined pressure level; pressurizing the cell employing CO2 gas at the second test station to a predetermined pressure level; and monitoring, via the second infrared camera, the exterior portion of the second portion of the cell to detect presence of CO2 gas when pressure in the cell at the second test station is at the predetermined pressure level.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates an isometric perspective of a leak testing system, in accordance with the disclosure.

FIG. 2 schematically illustrates a side view of a leak testing system, in accordance with the disclosure.

FIG. 3 schematically illustrates an isometric perspective of a portion of a leak testing system, in accordance with the disclosure.

FIG. 4A schematically illustrates a side view of a leak testing system having a backdrop in a retracted state, in accordance with the disclosure.

FIG. 4B schematically illustrates a side view of a leak testing system having a backdrop in an extended state, in accordance with the disclosure.

FIG. 5 illustrates a flowchart of a leak detection routine, in accordance with the disclosure.

The appended drawings are not necessarily to scale, and present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description provides details related to the concepts described and claimed, and is not intended to limit the application and uses. Furthermore, there is no intention to be bound by an expressed or implied theory presented herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

Embodiments may be described herein in terms of functional and/or logical block components and various processing steps. Such block components may be realized by a combination or collection of mechanical and electrical hardware, software, and/or firmware components configured to perform the specified functions. For example, an embodiment may employ various combinations of mechanical components and electrical components, integrated circuit components, memory elements, digital signal processing elements, logic elements, look-up tables, or the like, which may carry out a variety of functions under the control of one or more microprocessors or other control devices. In addition, those skilled in the art will appreciate that the illustrated embodiments may be practiced in conjunction with mechanical and/or electronic systems, and that the vehicle systems described herein are merely illustrative embodiments of possible implementations.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. Many alternative or additional functional relationships or physical connections may be present in an embodiment of the disclosure.

Furthermore, the first definition of an acronym or other abbreviation applies to subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this disclosure is not limited to the specific embodiments and methods described below, as specific components and/or conditions may, of course, vary. Furthermore, the terminology used herein is used for the purpose of describing particular embodiments of the present disclosure and is not intended to be limiting.

Also, as used in the specification and the appended claims, the singular form “a,” “an,” and “the” comprise plural referents unless the context clearly indicates otherwise. For example, reference to a component in the singular is intended to comprise a plurality of components.

The use of ordinals such as first, second and third does not necessarily imply a ranked sense of order, but rather may distinguish between multiple instances of an act or structure.

Numerical values of parameters (e.g., of quantities or conditions) in this specification, including the appended claims, are to be understood as being modified by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. Each value within a range and the endpoints of a range are hereby all disclosed as separate embodiments.

As employed herein, terms such as “vertical”, “horizontal”, “left”, “right”, “upper”, “lower”, and similar expressions are non-limiting terms that merely describe the various elements as illustrated in the Figures, and are not intended to limit the scope of the disclosure.

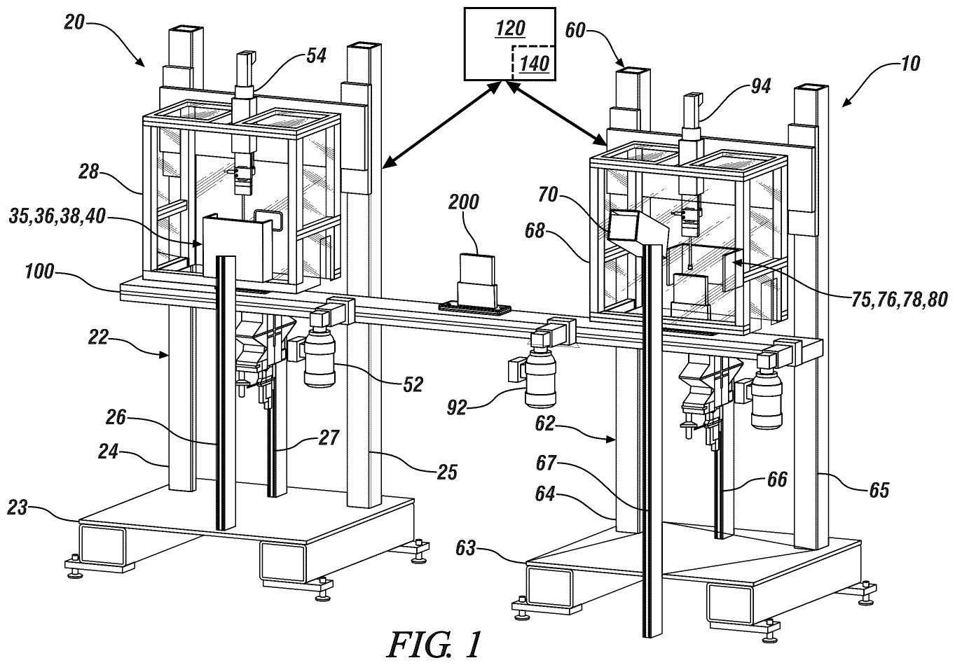

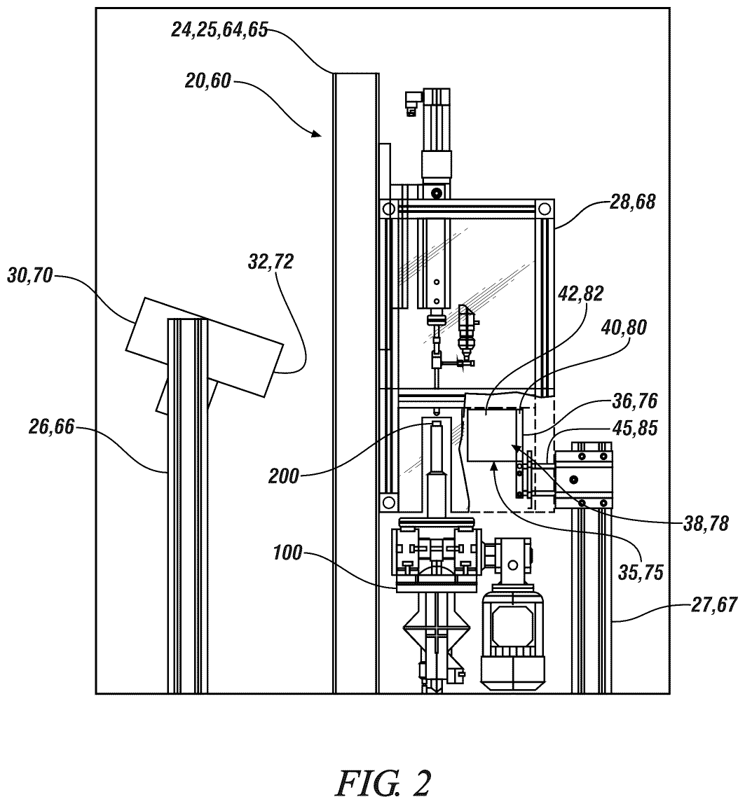

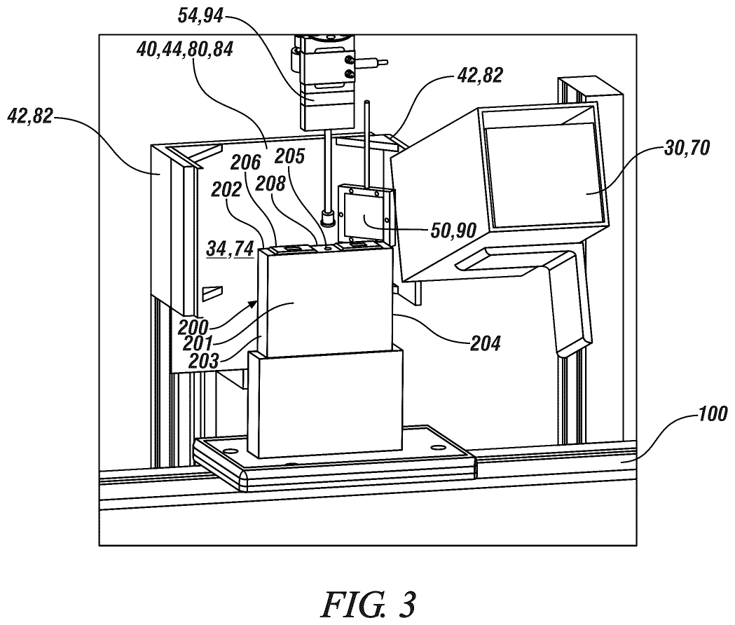

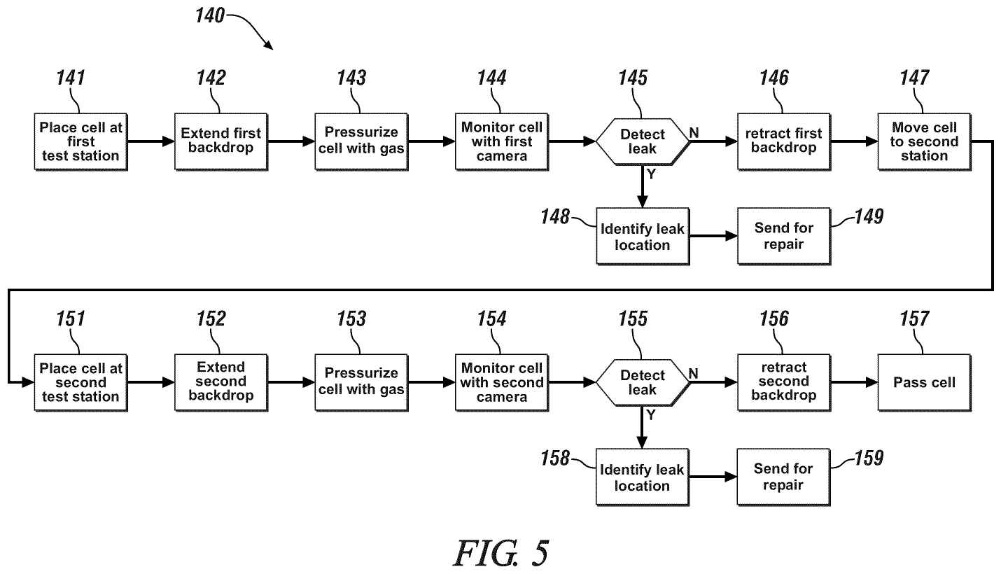

Referring now to the drawings, wherein the showings are for the purpose of illustrating certain exemplary embodiments and not for the purpose of limiting the same, FIGS. 1, 2, 3, 4A, and 4B schematically show various elements associated with a leak testing system 10 that may be advantageously fabricated and employed to execute a leak detection routine 140 on an embodiment of a prismatic battery cell 200, including executing the leak detection routine 140 on an embodiment of the prismatic battery cell 200 prior to filling a liquid electrolyte into a scalable pouch thereof. Details related to the leak detection routine 140 are described with reference to FIG. 5.

Referring again to FIGS. 1, 2, 3, 4A, and 4B, the leak testing system 10 includes a first test station 20, a second test station 60, a conveyor 100, and a controller 120. The first test station 20 is connected to the second test station 60 via the conveyor 100 to effect movement of the prismatic battery cell 200 from the first test station 20 to the second test station 60.

The prismatic battery cell 200 has an exterior portion that includes a first, nominally front side 201, a second, nominally rear side 202, a first end 203, a second end 204, a top side 205, and a bottom side (not shown), which are viewable by the leak testing system 10 in either or both the first test station 20 and/or the second test station 60.

The first and second test stations 20, 60 each employ machine vision in the form of an optical gas imaging (OGI) system to detect occurrence and location of a gaseous leak in an embodiment of the prismatic battery cell 200 by monitoring the exterior portion of the prismatic battery cell 200, i.e., the first, nominally front side 201, the second, nominally rear side 202, the first end 203, the second end 204, the top side 205, and the bottom side. The machine vision elements include, in one embodiment, a digital camera having a gas-specific lens filter and a non-reflective backdrop, which are employed in an environmental chamber, with signal processing of images captured by the digital camera being performed in the controller 120. The first and second test stations 20, 60 are each configured and arranged to fill the prismatic battery cell 200 with a pressurized gaseous substance, and employ the machine vision elements to detect occurrence and location of a gaseous leak on at least a portion of an outer surface of the prismatic battery cell 200, under static ambient airflow and thermal conditions.

The first test station 20 includes a first frame portion 22 that has a base portion 23, opposed legs 24, 25, a first mounting post 26, a second mounting post 27, and first environmental chamber 28. The first environmental chamber 28 is configured as a rectangular prism having transparent side and top portions and an open bottom portion. The first environmental chamber 28 is mounted on the first frame portion 22, and is employed to provide static ambient airflow and thermal conditions around the prismatic battery cell 200 during testing.

The OGI system of the first test station 20 includes a first infrared camera 30 equipped with a first optical lens filter 32, first backdrop 35, first mirror 50, first vacuum source 52, and first gas delivery system 54. In one embodiment, the first gas delivery system 54 is a CO2 gas delivery system, and the first optical lens filter 32 is in the form of an optical CO2 lens filter. Alternatively, another gaseous substance may be employed, with leak detection being performed by a corresponding imaging system.

The first infrared camera 30 is equipped with a first optical lens filter 32, and is in communication with controller 120. The first infrared camera 30 is mounted on the first mounting post 26 to have a first field of view (FOV) 34 that includes the prismatic battery cell 200 during testing. Location and mounting positions, working distances, angles, FOVs, and other parameters are application-specific, and are discernible by skilled practitioners.

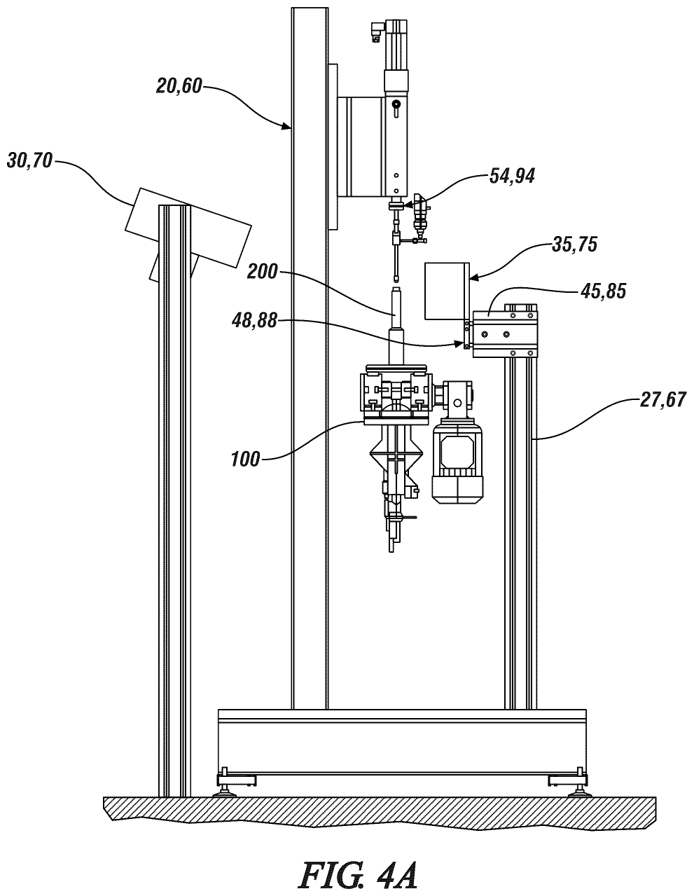

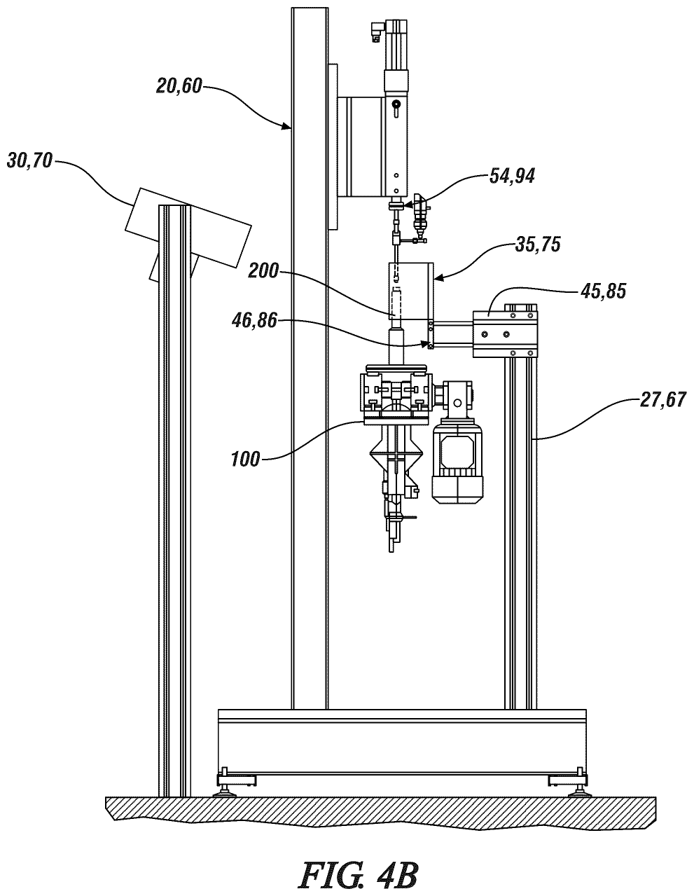

The first backdrop 35 is arranged as a first open-sided channel 38, e.g., a C-channel, which is mounted via a first controllable extender 45 on the second mounting post 27, with a first heating element 36 attached thereto. In one embodiment, the first open-sided channel 38 is fabricated from aluminum with a web portion 40 and side portions 42. The surface 44 of the first open-sided channel 38 is treated in a manner that minimizes or eliminates light reflectivity, especially infrared light reflectivity. In one embodiment, the surface 44 of the first open-sided channel 38 is anodized in black to minimize infrared light reflectivity. The first mirror 50 is arranged on the first backdrop 35 in a corner between the web portion 40 and one of the side portions 42. The first heating element 36 is a silicon or positive temperature coefficient heating device that is operatively connected to the controller 120, and is controllable to maintain a stable thermal environment within the first environmental chamber 28 during testing. The first controllable extender 45 is operable to position the first backdrop 35 in either a retracted position 48 (FIG. 4A) or an extended position 46 (FIG. 4B). In one embodiment, the first controllable extender 45 is configured as a pneumatic cylinder. The first backdrop 35 is advantageously positioned in the extended position 46 proximal to the prismatic battery cell 200 during leak testing, with the web portion 40 and side portions 42 thereof encompassing at least a portion of the prismatic battery cell 200. The first backdrop 35 is advantageously positioned in the retracted position 48 away from the prismatic battery cell 200 to allow movement of the prismatic battery cell 200 into or out of the first environmental chamber 28 prior to and after leak testing.

The first gas delivery system 54 may be a CO2 gas delivery system that is capable of sealably engaging a fill aperture 208 of an unfilled pouch 206 of the prismatic cell 200 and displacing air contained within the unfilled pouch 206 at a predetermined pressure for a period of time.

The second test station 60 is a duplicate of the first test station 20, in one embodiment.

The second test station 60 includes a second frame portion 62 that has a base portion 63, opposed legs 64, 65, a first mounting post 66, a second mounting post 67, and second environmental chamber 68. The second environmental chamber 68 is configured as a rectangular prism having transparent side and top portions and an open bottom portion. The second environmental chamber 68 is mounted on the second frame portion 62, and is employed to provide static ambient airflow and thermal conditions around the prismatic battery cell 200 during testing.

The OGI system of the second test station 60 includes a second infrared camera 70 equipped with a second optical lens filter 72, second backdrop 75, second mirror 90, second vacuum source 92, and second gas delivery system 94. In one embodiment, the second gas delivery system 94 is a CO2 gas delivery system, and the second optical lens filter 72 is in the form of an optical CO2 lens filter. Alternatively, another gaseous substance may be employed, with leak detection being performed by a corresponding imaging system.

The second infrared camera 70 is in communication with controller 120. The second infrared camera 70 is mounted on the first mounting post 66 to have a second field of view (FOV) 74 that includes the prismatic battery cell 200 during testing. Location and mounting positions, working distances, angles, FOVs, and other parameters are application-specific, and are discernible by skilled practitioners.

The second backdrop 75 is arranged as a first open-sided channel 78, e.g., a C-channel, which is mounted via a second controllable extender 85 on the second mounting post 67, with a second heating element 76 attached thereto. In one embodiment, the first open-sided channel 78 is fabricated from aluminum with a web portion 80 and side portions 82. The surface 84 of the first open-sided channel 78 is treated in a manner that minimizes or eliminates light reflectivity, especially infrared light reflectivity. In one embodiment, the surface 84 of the first open-sided channel 78 is anodized in black to minimize infrared light reflectivity. The second mirror 90 is arranged on the second backdrop 75 in a corner between the web portion 80 and one of the side portions 82. The second heating element 76 is a silicon or positive temperature coefficient heating device that is operatively connected to the controller 120, and is controllable to maintain a stable thermal environment within the second environmental chamber 68 during testing. The second controllable extender 85 is operable to position the second backdrop 75 in either a retracted position 88 or an extended position 86. In one embodiment, the second controllable extender 85 is configured as a pneumatic cylinder. The second backdrop 75 is advantageously positioned in the extended position 86 proximal to the prismatic battery cell 200 during leak testing, with the web portion 80 and side portions 82 thereof encompassing at least a portion of the prismatic battery cell 200. The second backdrop 75 is advantageously positioned in the retracted position 88 away from the prismatic battery cell 200 to allow movement of the prismatic battery cell 200 into or out of the second environmental chamber 68 prior to and after leak testing.

The second gas delivery system 94 may be a CO2 gas delivery system that is capable of sealably engaging a fill aperture 208 of an unfilled pouch 206 of the prismatic battery cell 200 and displacing air contained within the unfilled pouch 206 at a predetermined pressure for a period of time.

FIG. 4A schematically illustrates the first test station 20 with first infrared camera 30 equipped with first optical lens filter 32, wherein the first backdrop 35 is arranged in the retracted state.

FIG. 4B schematically illustrates the first test station 20 with first infrared camera 30 equipped with a first optical lens filter 32, wherein the first backdrop 35 is arranged in the extended state, i.e., the test state.

FIG. 5 illustrates a leak detection routine 140, which may be embodied as one or multiple algorithms that are captured in a non-volatile memory device of the controller 120 and executed to detect occurrence of a leak in an unfilled prismatic battery cell 200 employing the leak testing system 10 that is described with reference to FIGS. 1, 2, 3, 4A, and 4B. Table 1 is provided as a key wherein the numerically labeled blocks and the corresponding functions are set forth as follows, corresponding to the leak detection routine 140. The teachings may be described herein in terms of functional and/or logical block components and/or various processing steps. It should be realized that such block components may be composed of hardware, software, and/or firmware components that have been configured to perform the specified functions. As shown, the leak detection routine 140 is illustrated as a collection of blocks in a logical flow graph, which represents a sequence of operations that can be implemented in hardware, software, or a combination thereof. In the context of software, the blocks represent computer instructions that, when executed by one or more processors, perform the recited operations.

TABLE 1

| BLOCK | BLOCK CONTENTS |
|---|---|
| 141 | Place cell at first test station |
| 142 | extend first backdrop |
| 143 | pressurize cell with gas |
| 144 | monitor cell with first camera |
| 145 | detect leak? |
| 146 | retract first backdrop |
| 147 | move cell to second station |
| 148 | identify leak location |
| 149 | send for repair |
| 151 | place cell at second test station |
| 152 | extend second backdrop |
| 153 | pressurize cell with gas |
| 154 | monitor cell with second camera |
| 155 | detect leak |
| 156 | retract second backdrop |
| 157 | pass cell |
| 158 | identify leak location |
| 159 | send for repair |

Execution of the leak detection routine 140 may proceed as follows. The steps of the routine 140 may be executed in a suitable order, and are not limited to the order described with reference to FIG. 5. As employed herein, the term “Y” indicates an answer in the affirmative, or “YES”, and the term “N” indicates an answer in the negative, or “NO”. The leak detection routine 140 begins by arranging or otherwise placing an unfilled prismatic battery cell (cell) at the first test station (Step 141), and arranging the first backdrop in the first test position, wherein the first test position and thus the first backdrop are proximal to a first portion of the cell (Step 142). The cell is pressurized employing the first CO2 gas delivery system, including controlling the internal pressure of the pouch of the cell (Step 143). Imaging by the camera is triggered when the pressure inside the pouch reaches a predetermined minimum pressure level. The first infrared camera monitors at least a first portion of the cell and the first backdrop, seeking to detect or discern presence of CO2, which may indicate presence of a leak (Step 144). When the first infrared camera detects or discerns presence of CO2 (145)(Y), location of a leak on the cell is identified (Step 148), and the cell is removed from further testing and sent off-line for repair (Step 149). When the first infrared camera does not detect presence of CO2 (145)(N), the first backdrop is retracted (Step 146) and the cell is moved to the second station (Step 147).

The leak detection routine 140 continues by arranging or otherwise placing the unfilled prismatic battery cell (cell) at the second test station (Step 151), and arranging the second backdrop in the second test position, wherein the second test position and thus the second backdrop are proximal to a second portion of the cell (Step 152). The cell is pressurized employing the second CO2 gas delivery system, including controlling the internal pressure of the pouch of the cell (Step 153). Imaging by the camera is triggered when the pressure inside the pouch reaches a predetermined minimum pressure level. The second infrared camera monitors at least a second portion of the cell and the second backdrop, seeking to detect or discern presence of CO2, which may indicate presence of a leak (Step 154). When the second infrared camera detects or discerns presence of CO2 (155)(Y), location of a leak on the cell is identified (Step 158), and the cell is removed from further testing and sent off-line for repair, and for process improvement to prevent further leak-related faults in fabrication (Step 159). When the second infrared camera does not detect presence of CO2 (155)(N), the second backdrop is retracted (Step 156) and the cell is indicated to have passed the leak detection routine 140 and is moved to further processing (Step 157).

The first infrared camera is disposed to monitor a first field of view that includes the first backdrop when the first backdrop is in a first test position. The second infrared camera is disposed to monitor a second field of view that includes the second backdrop when the second backdrop is in a second test position. The controller is in communication with the first test station, the second test station, and the conveyor. The controller includes a cell test procedure that is captured in algorithmic code that is stored in non-volatile memory. The cell test procedure includes the following steps, including arranging an unfilled prismatic battery cell (cell) at the first test station; arranging the first backdrop and the first mirror in the first test position, wherein the first test position is proximal to a first portion of the cell; pressurizing the cell employing CO2 gas at the first test station; monitoring, via the first infrared camera, an exterior portion of the first portion of the cell to detect presence of CO2 gas; transporting, via the conveyor, the cell to the second test station; arranging the second backdrop and the second mirror in the second test position, wherein the second test position is proximal to a second portion of the cell; pressurizing the cell employing CO2 gas at the second test station; monitoring, via the second infrared camera, an exterior portion of the second portion of the cell to detect presence of CO2 gas; detecting, via the controller, a leak in the cell when the first infrared camera detects a presence of CO2 gas proximal to the exterior portion of the first portion of the cell; and detecting, via the controller, a leak in the cell when the second infrared camera detects a presence of CO2 gas proximal to the exterior portion of the second portion of the cell.

The terms controller, control module, module, control, control unit, processor and similar terms refer to various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions, including monitoring inputs from sensing devices and other networked controllers and executing control and diagnostic routines to control operation of actuators. Routines may be periodically executed at regular intervals, or may be executed in response to occurrence of a triggering event. Communication between controllers, and communication between controllers, actuators and/or sensors may be accomplished using a direct wired link, a networked communications bus link, a wireless link, a serial peripheral interface bus or another suitable communications link. Communication includes exchanging data signals in suitable form, including, for example, electrical signals via a conductive medium, electromagnetic signals via air, optical signals via optical waveguides, and the like. Data signals may include signals representing inputs from sensors, signals representing actuator commands, and communications signals between controllers.

The concepts described herein provide or enable an in-line Non-Destructive Testing (NDT) system which inspects individual prismatic cells during production and identifies leaks after welding of the cap assembly to can and prior to electrolyte filling. This technology further has the ability to locate the point of leakage to optimize welding reprocessing work. This system has two stations connected by a conveyor where the prismatic cell will be tested first in Station#1 and then moved to Station#2. Station#1 inspects the back and side edges of the cell and Station#2 inspects the front and side edges of the cell.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A leak testing system, the system comprising:
a first test station, a second test station, a conveyor, and a controller;
wherein the first test station is connected to the second test station via the conveyor;
wherein the first test station includes a first infrared camera equipped with a first optical CO2 lens filter, a first backdrop including a first mirror, and a first CO2 gas delivery system;
wherein the second test station includes a second infrared camera equipped with a second optical CO2 lens filter, a second backdrop including a second mirror, and a second CO2 gas delivery system;
wherein the first infrared camera is disposed to monitor a first field of view that includes the first backdrop when the first backdrop is in a first test position;
wherein the second infrared camera is disposed to monitor a second field of view that includes the second backdrop when the second backdrop is in a second test position;
wherein the controller is in communication with the first test station, the second test station, and the conveyor;
wherein the controller includes a cell test procedure that is captured in algorithmic code that is stored in non-volatile memory;
wherein the cell test procedure includes the following steps:
arrange an unfilled prismatic battery cell (cell) at the first test station;
arrange the first backdrop in the first test position, wherein the first test position is proximal to a first portion of the cell;
pressurize the cell employing the first CO2 gas delivery system;
monitor, via the first infrared camera, the cell and the first backdrop;
transport, via the conveyor, the cell to the second test station;
arrange the second backdrop in the second test position, wherein the second test position is proximal to a second portion of the cell;
pressurize the cell employing the second CO2 gas delivery system;
monitor, via the second infrared camera, the cell and the second backdrop;
detect, via the controller, a leak in the cell when the first infrared camera detects CO2 gas proximal to the cell; and
detect, via the controller, a leak in the cell when the second infrared camera detects CO2 gas proximal to the cell.

2. The leak testing system of claim 1, wherein the first backdrop comprises:
a first C-channel device having a web portion, first and second side portions, and a heating element;
wherein a surface of the web portion and the first and second side portions of the first C-channel device includes an infrared light absorbing treatment;
wherein the web portion and the first and second side portions are arranged to encompass the first portion of the cell when the first backdrop is arranged in the first test position.

3. The leak testing system of claim 2, wherein the first C-channel device is fabricated from aluminum, and wherein the surface of the web portion and the first and second side portions of the first C-channel device comprises a black anodized surface.

4. The leak testing system of claim 1, wherein the second backdrop comprises:
a second C-channel device having a web portion, first and second side portions, and a heating element;
wherein a surface of the web portion and the first and second side portions of the second C-channel device includes an infrared light absorbing treatment;
wherein the web portion and the first and second side portions are arranged to encompass the second portion of the cell when the second backdrop is arranged in the second test position.

5. The leak testing system of claim 4, wherein the second C-channel device is fabricated from aluminum, and wherein the surface of the web portion and the first and second side portions of the second C-channel device comprises a black anodized surface.

6. The leak testing system of claim 1, further comprising a first environmental enclosure and a second environmental enclosure, wherein the first test station is disposed in the first environmental enclosure, and wherein the second test station is disposed in the second environmental enclosure.

7. The leak testing system of claim 1, wherein the cell test procedure further includes a step to:
identify, via the controller, a location of the leak on the cell when the first infrared camera detects presence of CO2 gas proximal to the cell.

8. The leak testing system of claim 1, wherein the cell test procedure further includes a step to:
identify, via the controller, a location of the leak on the cell when the second infrared camera detects presence of CO2 gas proximal to the cell.

9. The leak testing system of claim 1, further comprising:
the first backdrop being attached via a first extender to a first frame portion of the first test station;
the first extender being controllable to one of a retracted state and an extended state; and
wherein the cell test procedure further includes steps to:
control the first extender to the extended state prior to the step to arrange the first backdrop and the first mirror in the first test position; and
control the first extender to the retract state prior to the step to transport, via the conveyor, the cell to the second test station.

10. The leak testing system of claim 1, further comprising:
the second backdrop being attached via a second extender to a second frame portion of the second test station;
the second extender being controllable to one of a retracted state and an extended state; and
wherein the cell test procedure further includes a step to:
control the second extender to the extended state prior to the step to arrange the second backdrop and the second mirror in the second test position.

11. The leak testing system of claim 1, wherein the cell test procedure further includes steps to:
pressurize the cell employing the first CO2 gas delivery system to a predetermined pressure level; and
monitor, via the first infrared camera, an exterior portion of the first portion of the cell to detect presence of CO2 gas when pressure in the cell at the first test station is at the predetermined pressure level.

12. The leak testing system of claim 1, wherein the cell test procedure further includes steps to:
pressurize the cell employing the second CO2 gas delivery system to a predetermined pressure level; and
monitor, via the second infrared camera, the exterior portion of the second portion of the cell to detect presence of CO2 gas when pressure in the cell at the second test station is at the predetermined pressure level.

13. A leak testing system, the system comprising:
a first test station arranged in a first environmental enclosure, a second test station arranged in a second environmental enclosure, a conveyor, and a controller;
wherein the first test station is connected to the second test station via the conveyor;
wherein the first test station includes a first camera, a first backdrop, a first mirror, and a first gas delivery system;
wherein the second test station includes a second camera, a second backdrop, a second mirror, and a second gas delivery system;
wherein the first camera is disposed to monitor a first field of view that includes the first backdrop when the first backdrop is in a first test position;
wherein the second camera is disposed to monitor a second field of view that includes the second backdrop when the second backdrop is in a second test position;
wherein the controller is in communication with the first test station, the second test station, and the conveyor; and
wherein the controller includes a cell test procedure that is captured in algorithmic code that is stored in non-volatile memory.

14. The leak testing system of claim 13, wherein the cell test procedure includes the following steps:
pressurize the cell with gas via the first gas delivery system at the first test station;
monitor, via the first camera, an exterior portion of a first portion of the cell to detect presence of the gas;
transport, via the conveyor, the cell to the second test station;
pressurize the cell with the gas via the second gas delivery system at the second test station;
monitor, via the second camera, an exterior portion of a second portion of the cell to detect presence of the gas;
detect, via the controller, a leak in the cell when the first camera detects presence of the gas proximal to the exterior portion of the first portion of the cell; and
detect, via the controller, a leak in the cell when the second camera detects presence of the gas proximal to the exterior portion of the second portion of the cell;
identify, via the controller, a location of the leak on the cell when the first camera detects presence of the gas proximal to the exterior portion of the cell.

15. The leak testing system of claim 13, wherein the cell test procedure further includes a step to:
identify, via the controller, a location of the leak on the cell when the second camera detects presence of the gas proximal to the exterior portion of the cell.

16. The leak testing system of claim 13, wherein the cell test procedure further includes steps to:
pressurize the cell employing the gas at the first test station to a predetermined pressure level; and
monitor, via the first camera, the exterior portion of the first portion of the cell to detect presence of the gas when pressure in the cell at the first test station is at the predetermined pressure level.

17. The leak testing system of claim 13, wherein the cell test procedure further includes steps to:
pressurize the cell employing the gas at the second test station to a predetermined pressure level; and
monitor, via the second camera, the exterior portion of the second portion of the cell to detect presence of the gas when pressure in the cell at the second test station is at the predetermined pressure level.

18. A method for leak testing, the method comprising:
arranging an unfilled prismatic battery cell (cell) at a first test station;
arranging a first backdrop and a first mirror in a first test position, wherein the first test position is proximal to a first portion of the cell;
pressurizing the cell employing CO2 gas;
monitoring, via a first infrared camera, an exterior portion of the first portion of the cell;
transporting the cell to a second test station;
arranging a second backdrop and a second mirror in a second test position, wherein the second test position is proximal to a second portion of the cell;
pressurizing the cell employing CO2 gas;
monitoring, via a second infrared camera, an exterior portion of the second portion of the cell;
detecting, via a controller in communication with the first infrared camera, a leak in the cell when the first infrared camera detects a presence of CO2 gas proximal to the exterior portion of the first portion of the cell; and
detecting, via the controller in communication with the second infrared camera, a leak in the cell when the second infrared camera detects a presence of CO2 gas proximal to the exterior portion of the second portion of the cell.

19. The method of claim 18, further comprising:
identifying, via the controller, a location of the leak on the cell when the first infrared camera detects presence of CO2 gas proximal to the exterior portion of the first portion of the cell; and
identifying, via the controller, the location of the leak on the cell when the second infrared camera detects presence of CO2 gas proximal to the exterior portion of the second portion of the cell.

20. The method of claim 18, further comprising:
pressurizing the cell employing CO2 gas at the first test station to a predetermined pressure level;
monitoring, via the first infrared camera, the exterior portion of the first portion of the cell when pressure in the cell at the first test station is at the predetermined pressure level;
pressurizing the cell employing CO2 gas at the second test station to a predetermined pressure level; and
monitoring, via the second infrared camera, the exterior portion of the second portion of the cell when pressure in the cell at the second test station is at the predetermined pressure level.
